(19) United States
(12) Patent Application Publication
(10) Pub. No.: US 2026/0310777 A1
(43) Pub. Date: Oct. 8, 2026

(54) DEVICE SECURITY SYSTEM AND METHOD

(71) Applicant: Sony Interactive Entertainment Inc., Tokyo (JP)

(72) Inventor: Thomas Anthony Mason, London (GB)

(73) Assignee: Sony Interactive Entertainment Inc., Tokyo (JP)

(21) Appl. No.: 19/638,914

(22) Filed: Apr. 3, 2026

(30) Foreign Application Priority Data
Apr. 4, 2025 (GB) 2505096.4

(51) Int. Cl. G06F 21/35; G06F 21/44

(52) U.S. Cl. CPC G06F 21/35; G06F 21/44

(57) ABSTRACT

Techniques are provided for detecting a theft of a device, the techniques comprising detecting one or more unrecognised devices, identifying one or more characteristics of the device's motion, determining if one or more unrecognised devices are within a threshold distance of the device, and determining whether one or more characteristics of the device's motion meets a threshold condition, and executing one or more security responses if one or more unrecognised devices are within a threshold distance and if the device's motion meets or exceeds the threshold condition.

### CROSS REFERENCE TO RELATED APPLICATIONS

This application claims the benefit of and priority to United Kingdom (GB) Application No. 2505096.4, filed Apr. 4, 2025, the entire disclosure of which is incorporated by reference herein in its entirety for all purposes.

### BACKGROUND OF THE INVENTION

### Field of the Invention

This disclosure relates to a device security system and method.

### Description of the Prior Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

The range of portable devices has increased significantly over time; not only have mobile phones become almost ubiquitous, but additional devices such as portable games consoles, smart watches, and tablet computers have also become increasingly common. Such devices have increased user convenience, allowing them to access computing functionality and other interactivity when away from home.

However, one drawback to these devices is that they can be a target for theft due to their high value and ease of portability. While some devices are provided with theft detection tools, such as snatch detection based upon accelerometer readings, it is considered that further tools may reduce the risk of theft further or aid the recovery of devices.

It is in the context of the above discussion that the present disclosure arises.

### SUMMARY OF THE INVENTION

One general aspect includes a method of detecting one or more unrecognised devices. The method can also include identifying one or more characteristics associated with a motion of a current device. The method can also include determining if the one or more unrecognised devices are within a threshold distance of the current device. The method can also include determining whether the one or more characteristics associated with the motion of the current device meets a threshold condition. The method can also include executing one or more security responses if the one or more unrecognised devices are within the threshold distance of the current device and if the one or more characteristics associated with the motion of the current device meets or exceeds the threshold condition. Other embodiments of this aspect include corresponding computer systems, apparatus, and computer programs recorded on one or more computer storage devices, each configured to perform the actions of the methods.

Implementations may include one or more of the following features. The method may include: where the detecting the one or more unrecognised devices may include communicating via at least one of: (i) near field communication, (ii) bluetooth, or (iii) wi-fi. Identifying the one or more characteristics associated with the motion of the current device is may be based on data from an accelerometer or a global positioning system (GPS) unit. The one or more characteristics may be at least one of: (i) speed, (ii) direction, or (iii) acceleration. The threshold condition may include at least one of a minimum speed or acceleration. The threshold condition may include one or more pairs of values which define ranges of values for the one or more characteristics associated with the motion of the current device. The one or more security responses can be a sound emitted from the current device. The one or more security responses may include causing is the current device to output information indicating a location of the current device. The one or more security responses may include causing the current device to modify one or more settings of the current device to prevent an unauthorised user to use the current device. Executing the one or more security responses can be based on a predicted transit status a user of the current device. The current device can be at least one of a mobile phone or portable games console. The method may be implemented by the device, or where the method may include a second device that is communicably connected to the device.

The method also includes detecting one or more unrecognised devices. The method also may include identifying one or more characteristics associated with a motion of a current device. The method also may include determining if the one or more unrecognised devices are within a threshold distance of the current device. The method also includes determining whether the one or more characteristics associated with the motion of the current device meets a threshold condition. The method also may include executing one or more security responses if the one or more unrecognised devices are within a threshold distance of the current device and if the one or more characteristics associated with the motion of the current device meets or exceeds the threshold condition.

The method may also include executing the one or more security responses based on a location of the current device. The method may also include obtaining identification data associated with the one or more unrecognised devices; transmitting the identification data to a second device associated with the current device; and storing the identification data at the current device. The one or more unrecognised devices may include at least one device not previously paired with the current device. The method may also include: suspending the execution of the one or more security responses in response to the current device connecting to a known network.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Other embodiments of this aspect include corresponding computer systems, apparatus, and computer programs recorded on one or more computer storage devices, each configured to perform the actions of the methods.

It is to be understood that both the foregoing general description of the invention and the following detailed description are exemplary, but are not restrictive, of the invention.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an entertainment system;

FIG. 2 schematically illustrates a method for detecting the theft of a first device;

FIG. 3 schematically illustrates a system for detecting theft of a device; and

FIG. 4 schematically illustrates a method for detecting theft of a device.

### DESCRIPTION OF THE EMBODIMENTS

Referring now to the drawings, wherein like reference numerals designate identical or corresponding parts throughout the several views, embodiments of the present disclosure are described.

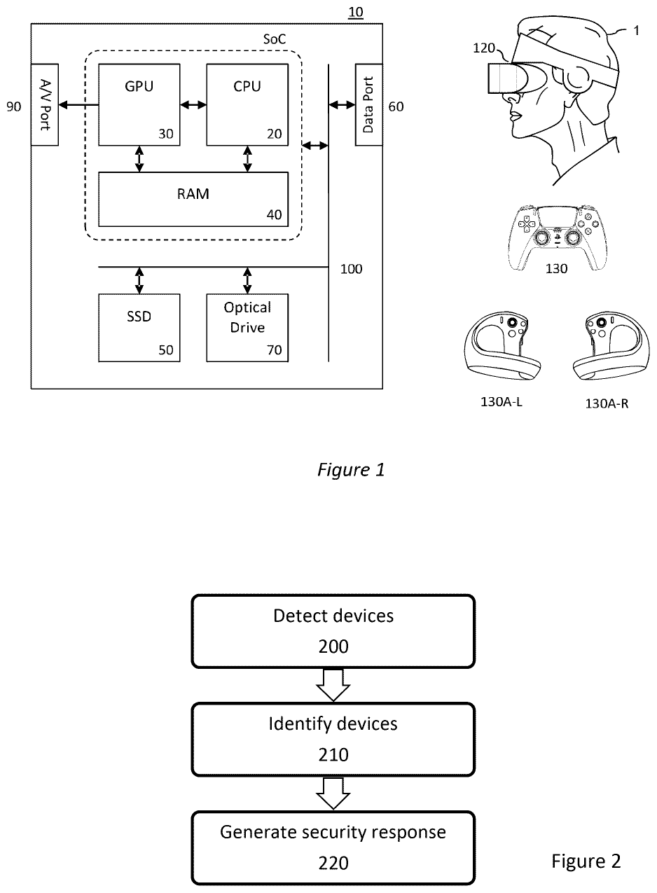

Referring to FIG. 1, an example of an entertainment system 10 is a computer or console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC).

Further storage may be provided by a disk 50, either as an external or internal hard drive, or as an external solid state drive, or an internal solid state drive.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90 or one or more of the data ports 60.

Where components are not integrated, they may be connected as appropriate either by a dedicated data link or via a bus 100.

An example of a device for displaying images output by the entertainment system is a head mounted display ‘HMD’120, worn by a user 1.

Interaction with the system is typically provided using one or more handheld controllers 130, and/or one or more VR controllers (130A-L, R) in the case of the HMD.

While the entertainment system 10 may be embodied as a games console or the like, it may also be implemented as an exemplary portable device. One or more modifications may be made in such a case, for instance omitting the optical drive 70 and providing a battery (not shown).

In implementations according to the present disclosure, a portable device may be any system which comprises at least a CPU 20, a data port 60, and a power source (such as a battery). That is, a portable device is a device which is able to provide processing functionality and communications without a mains power source being required-typically these would be battery-powered. Examples include mobile phones, portable games consoles, tablet computers, smart watches, and laptops; in some cases, peripherals such as games controllers and headphones may also provide sufficient functionality to fall under this definition.

Implementations according to the present disclosure provide a theft detection (and reaction) process which is responsive to the detection of unrecognised devices which are in proximity to a first device. Further factors may also be considered as a part of the theft detection and/or reaction processes, as described in more detail below.

An unrecognised device may be one which has not previously been paired with the user device; this is likely to encompass any device not owned by the same user or a friend/relative. In some cases, a device may be configured to store information relating to other devices as they are encountered-this may be via a background sensing process (such as monitoring detectable devices at a regular interval), or via detecting other devices which are connected to the same network (such as the user's home network). A device may be considered recognised after any detection/interaction; alternatively, a threshold number of detections/interactions may be required to avoid passer-by devices being identified as recognised too frequently. The information may be subject to any data policies as desired to manage the information-such as storing a ‘last detected’ date or the like, and deleting entries when this is too far in the past.

FIG. 2 schematically illustrates a method for detecting the theft of a first (portable) device, and taking an action in response to this detection. This is a process which operates on the basis that during normal use a portable device is unlikely to be in close proximity to multiple unrecognised devices; however during a theft it is likely that multiple devices have been stolen in quick succession, and that these will be stored together (such as in a thief's bag). While this may not be the case for all thefts (as a single device may be targeted), it is a scenario that is expected only to arise when a theft has occurred.

A step 200 comprises detecting one or more devices in proximity to the first device via one or more communication channels; it is not required that the devices connect to one another (such as performing a pairing process). These may be short-range communication channels, such as near-field communication (NFC), in which proximity may be identified based upon a successful detection. Alternatively, or in addition, longer-range communication channels such as Bluetooth® or Wi-Fi® may be used with processing performed to determine a distance between the first device and the detected devices, such that if the determined distance is below a threshold value then proximity is identified.

A step 210 comprises a determination of whether the detected devices are known to the first device; this may be determined on the basis of any device ID information that may be output by the detected devices via the communication channel or channels that are used by the devices (the device ID may be obtained from a communication channel other than one used to detect the device, in some implementations).

A step 220 comprises, in the case that unrecognised devices are detected, generating a security response by the first device; this is on the basis that the detection is expected to indicate that the first device has been stolen. The nature of the response may be determined based upon any of a number of different factors; the response may also be user-or manufacturer-defined. Factors that may be considered are the number of unrecognised devices, motion of the device, whether it is locked or unlocked, and whether any recognised devices are detected. A response may be to increase the security level of the first device (such as requiring biometric unlocking, rather than a pin code), initiating one or more applications (such as one which allows remote access and tracking of the first device), blocking one or more applications (such as banking applications), generating an alarm, and/or contacting one or more people or services (such as the police or other law enforcement). The severity of the response may correlate with the level of certainty of the detection of the theft of the first device.

In some implementations the method of FIG. 2 may be initiated on a conditional basis, rather than being continuously implemented. Any of a number of different conditions may be used to initiate the method, either alone or in combination. A first example of a condition is that of a failed authentication or login process being performed on the device; this is likely indicative of a person other than the owner of the device attempting to use the device. Another example is that of motion data; the method may be initiated in response to an uncharacteristic or other predetermined motion-such as a rapid acceleration of the device (which may be indicative of the device being snatched by a person on a powered vehicle such as an e-scooter). Any other additional or alternative conditions may also be considered, with the conditions being considered indicative of at least a possibility or likelihood of the device having been stolen. This may be advantageous in both improving the energy efficiency of the device, and in reducing the likelihood of false alarms.

Alternatively, or in addition, such conditions may be considered as a part of step 220 of FIG. 2 (or an additional step between steps 210 and 220) so as to form a part of the determination as to whether to generate a security response. In other words, the generation of the security response may be dependent upon the detection of unrecognised devices in step 210 in addition to one or more other conditions being satisfied either alone or in combination. In some implementations, each of a plurality of conditions may be associated with a score or weighting, with a security response being triggered when a sum (or other function) of these exceeds a threshold value.

One or more of the conditions may be motion-based, with the motion being detected by one or more hardware motion sensors (such as accelerometers) or using GPS data or the like. Conditions may be based upon threshold accelerations or speeds, for example, as well as a duration for which accelerations or speeds are maintained. These thresholds may be defined on a per-user basis in dependence upon their typical usage, for instance, and may also consider a geographical location. A sharp change in the motion direction may also be considered an indicator of a device being stolen.

For instance, a user that frequently rides a motorbike may subject their device to frequent sharp accelerations and so this condition may be suspended or threshold values may be chosen which would exclude such activities from being considered an indicator of theft. Similarly, if a user is detected to be at a train station (or otherwise on a train line), then thresholds may be changed so as to avoid the motion of the train triggering a security response erroneously.

Thresholds may be defined such that an above-threshold or below-threshold response is sufficient to satisfy a condition; however it is also considered that a plurality of thresholds may be defined for a given condition or variable. For instance, one or more ‘bands’ of speeds or accelerations may be defined so as to include or exclude particular circumstances. In one example, a condition relating to the speed is defined by thresholds which encompass the typical operating speed of an e-scooter such that slower motion or faster motion would not contribute to the triggering of a security response. A second speed band may also be defined to encompass running speeds, as this may be another speed which may be associated with the theft of the device (particularly when combined with considerations of the device's acceleration).

By tracking the location of the device, further geographical conditions may be considered. For instance, a device may be familiar with a user's commute (or another common journey which is performed at regular times); alternatively, or in addition, information about a user's intended destination and/or route can be identified from a navigation application being executed by the device. If there is a significant deviation from the expected journey, this may be indicative of the device having been stolen-for instance, if the user's device is detected to have strayed from the user's usual commuting route. While this may not be conclusive in isolation, this condition may be a significant factor to consider as a part of a group of possible conditions which indicate theft of the device.

Another spatial condition may be based upon a separation from one or more peripherals (or other devices) connected to the device. For instance, if a device is using Bluetooth® headphones to provide an audio output, and this connection is interrupted unexpectedly (for instance, with no indication of low battery or powering off of the device prior to the connection being interrupted), then it may be taken as an indicator that the device is no longer on the user's person. Similarly, even if an active connection is not being utilised the presence of known devices can be used as an indicator in the same manner (in that if known devices are no longer able to be detected, the device may have been stolen).

In a similar vein, information about detected or connected networks may be utilised in determining one or more conditions. In one example, if the device is able to detect (or connect to) the user's home network (or another trusted network) then security responses may be suspended—as it can be assumed that the user's device has not been stolen. In another example, if the detected networks are changing regularly then this may be indicative of being in a public place—and therefore a higher chance of a theft occurring may be assumed. If the rate of change of the networks is sufficiently high, this can be used as a proxy for a location/motion detection in determining that the device is moving at a high speed (and therefore may have been stolen) or can seek to confirm that the location/motion detection is correct (or at least plausible).

Another condition that may be considered is that of the types of other devices that are detected; this may be able to be determined based upon information output by those devices, for example. A number of conditions can be defined based upon such a consideration; these may be specific to a given user or device type, or may be responsive to other conditions where appropriate. In some examples, a condition may be satisfied in the case that the detected other devices comprise an above—threshold number of the same device type (such as mobile phone, portable games console, or laptop). This is unlikely to be a condition that is satisfied when a device is carried by a user (who is unlikely to carry, say, five mobile phones), but is more likely to be satisfied during the theft of devices. Similarly, a single user is unlikely to carry a group of devices comprising two mobile phones, two games consoles, and a tablet computer—with such an overlap in functionality between devices, at least one of the devices is likely to be redundant (and therefore such a group would be unlikely to be carried). It is therefore apparent that the makeup of a group of detected devices (rather than purely the number of devices) may be considered indicative of whether a theft has occurred.

In addition to the detection of unknown devices which are in proximity, the method may include a consideration of the length of time for which those devices are in proximity. For instance, a minimum threshold for a security response to be implemented may be set—thereby avoiding (or at least reducing the likelihood of) false responses due to passing by people in a busy train station or the like. A graduated security response may also be provided, in which the response increases in magnitude as the time spent with the unknown devices increases.

The other devices may be configured to output information other than information which allows their identity to be determined, so as to aid the determination of whether a security response should be generated. This output of information may be a constant feature, or may be a feature that is initiated in response to a determination that a device has been stolen or at least a threshold degree of suspicion that a device has been stolen (such as one or more conditions being met which aren't weighted heavily enough to be considered conclusive on whether the device has been stolen).

A first example of such information is an identity of the user of the device; even if a device is not recognised, a user ID or the like may be recognised. This may be useful in the case in which a user meets up with friends who have new phones—those phones may be logged in to the same user accounts as the old phones, and therefore could be recognised, but the devices themselves would not be recognised. The user ID may comprise any suitable information; in order to protect user privacy, a hash or the like may be output which can be compared to a look-up table at the user's device in order to determine whether the user of the other device is known.

A second example of such information is if a device is configured to output a signal when it suspects that a theft has occurred. If multiple such signals are identified, this indicates that multiple devices have each concluded that a theft has occurred. This can be used to confirm that a device has been stolen (effectively crowdsourcing the theft detection), and/or can be used as an input when determining an appropriate security response.

A third example is that a device may output an indicator of whether the device is unlocked or not. It is often preferred that devices are stolen while unlocked, so as to allow easier access to the data stored on those devices; it is also considered that devices which are legitimately in transit in proximity with other devices are likely to be locked (for instance, when in a user's bag). It is therefore considered that if one or more of the unknown devices are also unlocked, this is likely an indicator that a theft has occurred. A condition relating to the unlock state of the user's device may also be considered; this is on the same basis.

It is therefore apparent that there are a number of different conditions that may be implemented as a part of the theft detection and security response determination process, as demonstrated by the examples above. A number of different sensors may be implemented, each of which is used to capture information that may be indicative of a device no longer being with the user and/or instead being in unfamiliar circumstances (such as in an unusual location, or without commonly-associated peripherals).

As discussed above with reference to step 230 of FIG. 2, the security response can take a number of different forms. These may be based upon user preferences, a degree of certainty that the device has been stolen, and/or an elapsed time since a determination of theft was made; other factors may also be considered as appropriate for a given implementation. While the examples below are discussed in a particular order, this is by no means restrictive; the order in which particular responses are implemented may be selected freely, and two or more responses may be selected for implementation at a single time.

A first example of a security response is to lock the device if it is not already locked; this may also be paired with an increase in the security of the device such as requiring a biometric unlock instead of a PIN. Additional security settings may include requiring the unlock to be approved by another person (such as a trusted friend or partner, with a request being sent to their device or in an email), requiring the next unlock to be performed in a designated safe place (such as the user's home or workplace), or use of an additional hardware device (such as a USB token) to authenticate the login attempt.

A second example of a security response is to limit the functionality of the device; at its extreme end, this may include bricking the device so as to prevent its use by a thief to obtain the user's information. Limitations to functionality can include disabling touchscreen inputs (causing the next unlock to be via biometric input, for example), limiting network connectivity, or any other modifications.

Another example is that of generating an output which attracts attention to the theft this can include the generation of an alarm sound, for example, or an output which can be provided to nearby devices to make them aware of the theft (such as wirelessly transmitting a message, or a signal that causes the display of a message). This may have the additional benefit of reducing the likelihood of further thefts occurring, as other people may be able to be pre-warned.

In addition to modifying the operation of the device that has been stolen, security responses may be provided to help track the device. A first example of this is reporting the theft to a central database, such as one which is associated with an operating system of the device. This can be used to mark the device as stolen, such that access to certain features can be blocked remotely and/or the device will be tracked (via the device's positioning functions and/or an IP address, for instance) when it is next seen online.

Another security response relating to the tracking of the device is the use of GPS functionality or the like to generate positional information that can be reported. This may be via a web portal, for instance, transmission to another of the user's devices, and/or saving to a user's profile associated with the device. Each of these enables remote access of the devices location. This can be used by law enforcement to recover the device, for instance.

In either of these cases, the device reporting the theft or outputting positional information may also be configured to output data identifying the other devices which have been detected. This may be advantageous in the case that the devices have different functionalities that may impact their ability to do the same. For instance, a portable game console may not have a mobile data connection and therefore may not be able to report their own theft or positional information; alternatively, a device may not have access to positional information and therefore cannot effectively report their location. A server may also use the additional information in a confirmatory manner, such as using multiple sets of location information from respective devices to ensure a reliable location is being tracked.

A further type of security response relates to the gathering of evidence relating to the theft. This can be used during prosecution, for example, and/or recovery of the stolen devices; it may be preferable in this case that the evidence is output to a remote device or server to enable access. An example of this is causing the device to capture images, audio, and/or video. While in many cases the output may be uninformative (such as images of the inside of a bag), useful images/audio/video may be captured at some point during the theft (for instance, when the device is removed from the bag). The capturing of this content may be triggered by one or more motion conditions, or audio/visual triggers (such as lighting levels changing); by making the capturing conditional, battery power and storage space may be utilised more efficiently.

It may also be considered useful as evidence to track the identity of detected devices over time; particularly those that are unrecognised. This can provide a useful timeline of thefts, as well as potentially being able to be used to identify if one of the detected devices belongs to the thief. Being able to identify the thief's device is of course valuable information when seeking to recover stolen devices or prosecute the thief.

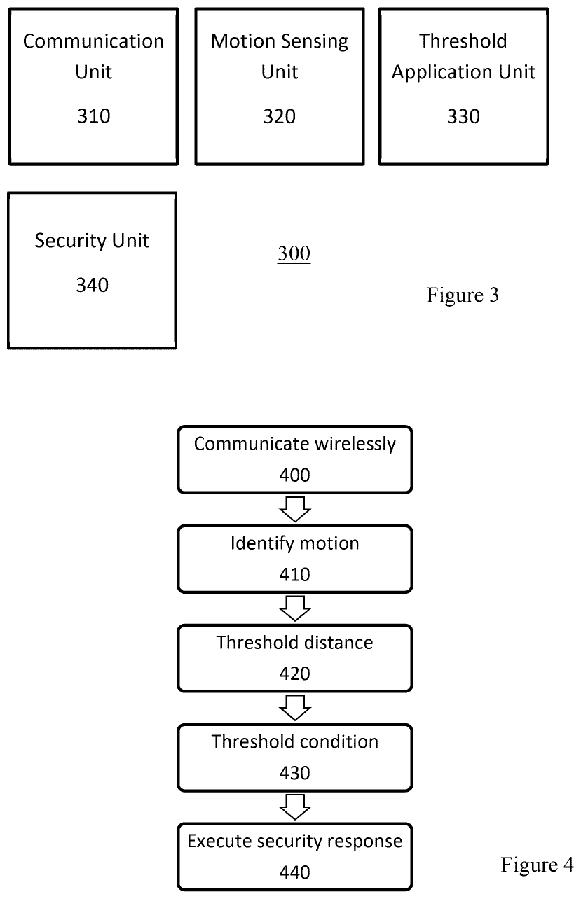

FIG. 3 schematically illustrates a system 300 for detecting a theft of a device, the system comprising a communication unit 310, a motion sensing unit 320, a threshold application unit 330, and a security unit 340. The device may be a mobile phone or a portable games console, for example, although any portable device (such as wireless headphones) may be compatible with such a system. The system 300 may be comprised as a part of the device itself (such as the functionality being provided by a processor of the device).

Alternatively, the system 300 may be implemented using separate hardware which is in communication with the device (via a wireless and/or wired communication as preferred); in other words, the system 300 may be second device that is communicably connected to the device. For example, the system 300 may be implemented as a part of a protective case for a device, an accessory for aiding user grip of the device, or any other accessory or peripheral. In this case, the system 300 may be configured to communicate with servers or the like (as a part of the security response) directly, or this may be performed by the device under instruction of the system 300. Similarly, the system 300 may comprise a number of sensors itself and/or utilise sensors of the device in order to obtain information (or receive the results of such sensing from the device in order to perform processing).

The communication unit 310 is configured to communicate wirelessly with one or more other devices (that is, one or more devices other than the device for which detection of theft is performed). The communication may take any form-it is not necessary that a pairing or the like is performed, but some form of device identifier should be exchanged between the devices or at least obtained from the one or more other devices.

The communication unit 310 may be configured to communicate via near field communication (NFC), Bluetooth®, and/or Wi-Fi as preferred; however any wireless communication protocol may be utilised as desired. A particular wireless communication protocol may be selected on the basis of any of a number of considerations, such as power consumption, range, and ubiquity amongst portable devices. It may be preferable to utilise multiple wireless communication protocols, as this may increase the number of devices which are able to be detected (as not all devices have NFC capabilities, for example) and/or allow the identification of different information about the other devices.

As described above, such communications may be responsive to one or more conditions being satisfied (rather than being run continuously); these conditions may be based upon unexpected motion of the device, for example, or a failed authentication attempt for a device unlock process.

The motion sensing unit 320 is configured to identify one or more characteristics of the device's motion. The motion sensing unit 320 may comprise an accelerometer and/or GPS unit, or otherwise receive data from such sensors. The motion sensing unit 320 may be configured to identify a speed, direction, and/or acceleration as characteristics of the device's motion.

The threshold application unit 330 is configured to determine if one or more unrecognised devices (amongst the one or more other devices with which wireless communications are performed) are within a threshold distance of the device based upon wireless communications, and to determine whether one or more characteristics of the device's motion meets a threshold condition.

The threshold distance may be defined by the communication range of a particular wireless communication protocol (such as NFC), and therefore represent a hardware limit. Alternatively, or in addition, the threshold distance may be defined as a particular value in order to balance reliability of detection of theft against the occurrence of false positives. For instance, a threshold distance of one metre, half a metre, quarter of a metre, or a tenth of a metre may be defined. The threshold distance may be responsive to one or more other conditions, such that a dynamic value is used in response to changing conditions. For instance, at high speeds the threshold distance may be reduced as this may be indicative of travelling on a train or bus.

The threshold condition (or conditions) may include any parameters as desired. For instance, the threshold condition comprises a minimum speed and/or acceleration, or one or more pairs of values which define ranges of values (such as the speed value bands described above) for one or more motion characteristics. The threshold condition may also be responsive to the direction or velocity of travel, or changes to this, where appropriate.

The security unit 340 is configured to execute one or more security responses if one or more unrecognised devices are within a threshold distance and if the device's motion meets or exceeds the threshold condition; these may be implemented directly in the case that the system is implemented by the device, or the system may instruct a particular response by the device where appropriate. A security response may be any action taken by the system or device which assists in the recovery of the device and/or makes it more difficult for the device to be used by a person other than the owner of the device (such as preventing access to applications or user data), for example.

For instance, the security unit 340 may be configured to cause the device to emit an alarm; this may comprise any audio and/or visual output which may draw attention. The alarm may also comprise a data transmission broadcast to nearby devices, to raise an alarm and/or warn other device users that a thief is in their vicinity.

The security unit 340 may also, or instead, be configured to cause the device to output information indicating a location of the device. This may be output to any appropriate recipient such as an online portal allowing a user to track their device, a network associated with the operating system of a device, and/or a law enforcement portal which can store information about the theft.

The security unit 340 may be configured to cause the device to modify one or more settings to make it more difficult for an unauthorised user to use the device. This may include locking the device if it is currently unlocked, adding additional security (such as a password) to one or more applications (such as banking, password manager, authentication, or file browsing applications), changing the unlock method (for instance, from a four-digit pin to a biometric login), or any other modifications.

The security unit 340 may further be configured to execute one or more security responses in dependence upon the location of the device; for instance, in some locations the responses may be suspended (such as a user's home), while in others they may be changed to be less obtrusive (such as when on a train, to mitigate the disruption of a false positive theft detection). The security unit 340 may also (or instead) be configured to execute one or more security responses in dependence upon information indicating an intended or likely travel by the user of the device such as information regarding a navigation that is in progress, or information about a user's routine (such as a commute to work). Significant deviations from such routes may contribute to the triggering of a security response.

The arrangement of FIG. 3 is an example of a processor (for example, a GPU and/or CPU located in a games console or any other computing device) that is operable to detect the theft of a device, and in particular is operable to:
communicate wirelessly with one or more other devices;
identify one or more characteristics of the device's motion;
determine if one or more unrecognised devices are within a threshold distance of the device based upon wireless communications;
determine whether one or more characteristics of the device's motion meets a threshold condition; and
execute one or more security responses if one or more unrecognised devices are within a threshold distance and if the device's motion meets or exceeds the threshold condition.

FIG. 4 schematically illustrates a method, for execution by a system, for detecting a theft of a device. The system is provided in accordance with the discussion of FIG. 3, and may be separate to the device or implemented as a part of the device.

A step 400 comprises communicating wirelessly with one or more other devices.

A step 410 comprises identifying one or more characteristics of the device's motion.

A step 420 comprises determining if one or more unrecognised devices are within a threshold distance of the device based upon wireless communications.

A step 430 comprises determining whether one or more characteristics of the device's motion meets a threshold condition.

A step 440 comprises executing one or more security responses if one or more unrecognised devices are within a threshold distance and if the device's motion meets or exceeds the threshold condition.

The techniques described above may be implemented in hardware, software or combinations of the two. In the case that a software-controlled data processing apparatus is employed to implement one or more features of the embodiments, it will be appreciated that such software, and a storage or transmission medium such as a non-transitory machine-readable storage medium by which such software is provided, are also considered as embodiments of the disclosure.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

What is claimed is:

1. A system comprising:
one or more processors; and
one or more computer-readable media storing instructions which, when executed by the one or more processors, cause the system to perform operations comprising:
detecting one or more unrecognised devices;
identifying one or more characteristics associated with a motion of a current device;
determining if the one or more unrecognised devices are within a threshold distance of the current device;
determining whether the one or more characteristics associated with the motion of the current device meets a threshold condition; and
executing one or more security responses if the one or more unrecognised devices are within the threshold distance of the current device and if the one or more characteristics associated with the motion of the current device meets or exceeds the threshold condition.

2. The system of claim 1, wherein the detecting the one or more unrecognised devices comprises communicating via at least one of: (i) near field communication, (ii) Bluetooth®, or (iii) Wi-Fi.

3. The system of claim 1, wherein the identifying the one or more characteristics associated with the motion of the current device is based on data from an accelerometer or a Global Positioning System (GPS) unit.

4. The system of claim 1, wherein the one or more characteristics is at least one of: (i) speed, (ii) direction, or (iii) acceleration.

5. The system of claim 1, wherein the threshold condition comprises at least one of a minimum speed or acceleration.

6. The system of claim 1, wherein the threshold condition comprises one or more pairs of values which define ranges of values for the one or more characteristics associated with the motion of the current device.

7. The system of claim 1, wherein the one or more security responses is a sound emitted from the current device.

8. The system of claim 1, wherein the one or more security responses comprises causing is the current device to output information indicating a location of the current device.

9. The system of claim 1, wherein the one or more security responses comprises causing the current device to modify one or more settings of the current device to prevent an unauthorised user to use the current device.

10. The system of claim 1, wherein the executing the one or more security responses is based on a predicted transit status a user of the current device.

11. The system of claim 1, wherein the current device is at least one of a mobile phone or portable games console.

12. The system of claim 1, wherein the system is implemented by the device, or wherein the system is a second device that is communicably connected to the device.

13. A method comprising:
detecting one or more unrecognised devices;
identifying one or more characteristics associated with a motion of a current device;
determining if the one or more unrecognised devices are within a threshold distance of the current device;
determining whether the one or more characteristics associated with the motion of the current device meets a threshold condition; and
executing one or more security responses if the one or more unrecognised devices are within a threshold distance of the current device and if the one or more characteristics associated with the motion of the current device meets or exceeds the threshold condition.

14. The method of claim 13, wherein the executing the one or more security responses is based on a location of the current device.

15. The method of claim 13, further comprising:
obtaining identification data associated with the one or more unrecognised devices;
transmitting the identification data to a second device associated with the current device; and
storing the identification data at the current device.

16. The method of claim 13, wherein the one or more unrecognised devices comprises at least one device not previously paired with the current device.

17. The method of claim 13, further comprising:
suspending the execution of the one or more security responses in response to the current device connecting to a known network.

18. One or more non-transitory computer-readable media storing instructions which, when executed by one or more processors, cause the one or more processors to perform operations comprising:
detecting one or more unrecognised devices;
identifying one or more characteristics associated with a motion of a current device determining if the one or more unrecognised devices are within a threshold distance of the current device;
determining whether the one or more characteristics associated with the motion of the current device meets a threshold condition; and
executing one or more security responses if the one or more unrecognised devices are within a threshold distance of the current device and if the one or more characteristics associated with the motion of the current device meets or exceeds the threshold condition.

19. The one or more non-transitory computer-readable media of claim 18, wherein the detecting the one or more unrecognised devices comprises communicating via at least one of: (i) near field communication, (ii) Bluetooth®, or (iii) Wi-Fi.

20. The one or more non-transitory computer-readable media of claim 18, wherein the one or more characteristics is at least one of: (i) speed, (ii) direction, or (iii) acceleration.
